(19) United States
(12) Patent Application Publication
(10) Pub. No.: US 2026/0070012 A1
(43) Pub. Date: Mar. 12, 2026

(54) MULTI-CHANNEL ADSORPTION TOWER AND DESORPTION REGENERATION PROCESS

(71) Applicant: East China University of Science and Technology, Shanghai (CN)

(72) Inventors: Zhishan BAI, Shanghai (CN); Mengyao QIN, Shanghai (CN); Zhaojin LU, Shanghai (CN); Xiaoyong YANG, Shanghai (CN); Jianguo SUN, Shanghai (CN); Qinghai HUANG, Shanghai (CN)

(21) Appl. No.: 19/323,480

(22) Filed: Sep. 9, 2025

(30) Foreign Application Priority Data
Sep. 10, 2024 (CN) 202411262457

(51) Int. Cl. B01D 53/04; B01D 15/20; B01D 15/22; B01J 20/08; B01J 20/28; B01J 20/34; C10G 25/12; C10L 3/10

(52) U.S. Cl. CPC B01D 53/0423; B01D 15/203; B01D 15/22; B01J 20/08; B01J 20/28004; B01J 20/28016; B01J 20/3433; B01J 20/3458; B01J 20/3475; C10G 25/12; C10L 3/101; B01D 2253/104; B01D 2253/304; B01D 2257/304; B01D 2259/40086

(57) ABSTRACT

The present disclosure provides a multi-channel adsorption tower including a tower body, an upper head, a lower head, tray assemblies, partition assemblies, a support plate, ceramic balls and an adsorbent. The interior of the adsorption tower is divided from bottom to top into a feed chamber, a first-stage adsorption chamber, a second-stage adsorption chamber, a third-stage adsorption chamber and a discharge chamber in sequence by the tray assemblies. Each adsorption chamber is equally divided into four material compartments by the partition assemblies. The adsorption chambers are filled with the adsorbent, and unloading ports are provided at the outside of each adsorption chamber. A feed port is provided at the bottom of the lower head, and a discharge port is provided at the top of the upper head. The feed chamber and the discharge chamber contain ceramic balls. The arrangement provides two material paths in the adsorption tower.

### CROSS-REFERENCE TO RELATED APPLICATION

The present application claims priority to Chinese Patent Application No. 202411262457.X filed on Sep. 10, 2024, the entire contents of which are hereby incorporated by reference into this application.

### TECHNICAL FIELD

The present disclosure relates to the field of chemical equipment, and in particular to a multi-channel adsorption tower and a desorption regeneration process.

### BACKGROUND ART

Sulfur exists in petrochemical products mainly in the form of elemental sulfur, hydrogen sulfide, mercaptans, thioethers, disulfides or thiophene. In petroleum refining processes, these sulfur-containing matters have a significant impact on product quality, processing, equipment corrosion, the environment, etc. With the increasing global attention to environmental protection and sustainable development, desulfurization processes for petrochemical products have attracted more and more attention. Common desulfurization processes include hydrodesulfurization, adsorption desulfurization or oxidative desulfurization. Among them, adsorption desulfurization has attracted widespread attention due to its advantages such as low process cost, no hydrogen consumption, no change in product properties, easy adsorbent regeneration and mild reaction conditions.

Adsorption desulfurization is a technology in which an adsorbent is used in an adsorption tower to selectively adsorb sulfur-containing substances from a material. The selected adsorbent is the core of the desulfurization technology. Currently, the solid adsorption materials that have been most widely studied include carbon materials, molecular sieves and metal oxides. Among them, alumina is an adsorption material that has been used in adsorption desulfurization very early. It has the advantages of high efficiency, environmental friendliness, regenerability and good desulfurization effect. Regeneration is an effective process for treating adsorption materials. The main adsorbent regeneration processes include thermal regeneration, wet oxidation regeneration, solvent regeneration and biological regeneration. Among them, thermal regeneration is a process that is used the most widely in industry for regeneration of adsorption materials. It has the advantages of good general performances, short regeneration time, high regeneration efficiency, etc., but suffers from a general problem of large heat loss.

The design of an adsorption tower determines to a large extent the desulfurization effect of an adsorption desulfurization process. However, the existing adsorption towers generally face such challenges as an excessively short adsorption path, nonuniform adsorption distribution of an adsorbent, the need for frequent replacement of an adsorbent, poor adsorption desulfurization effect, etc.

Therefore, it is particularly important to design an adsorption tower that is efficient, environmentally friendly, time-saving, and capable of improving the utilization rate of an adsorbent.

### SUMMARY

An object of the present disclosure is to provide a multi-channel adsorption tower and a desorption regeneration process, which can extend the adsorption path in the adsorption tower, and realize unremitting regeneration and adsorption of the adsorbent in the tower, thereby increasing the adsorption desulfurization efficiency. Particularly, the present disclosure aims to solve the following problems: (1) the problems of insufficient utilization of the adsorbent and easy wear of the adsorbent due to nonuniform distribution of the material in a traditional adsorption tower; (2) the problems of an excessively short adsorption path and a low utilization rate of the space in the adsorption tower due to simple stacking and unreasonable layout of the adsorbent; (3) the problems of adsorption interruption, a low adsorption processing capacity, high consumption of time and labor, and inconvenient operations due to separation of the adsorption tower and the desorption tower; and (4) the problems of high heat loss and harsh operating conditions in the thermal regeneration process for the adsorbent.

The specific technical solutions according to the present disclosure include:

A multi-channel adsorption tower, characterized in that the adsorption tower comprises: a tower body, an upper head, a lower head, tray assemblies, partition assemblies, a support plate, ceramic balls and an adsorbent;
wherein the adsorption tower is divided from bottom to top into a feed chamber, a first-stage adsorption chamber, a second-stage adsorption chamber, a third-stage adsorption chamber and a discharge chamber in sequence by the tray assemblies, wherein the feed chamber and the discharge chamber each are equally divided into two material compartments by the partition assemblies; each adsorption chamber is equally divided into four material compartments by the partition assemblies; the feed chamber is located in the lower head; the adsorption chamber of each stage is located in the tower body; the discharge chamber is located in the upper head; the support plate is welded to an inner wall of the adsorption tower for supporting the tray assemblies and the partition assemblies; the two material compartments of the feed chamber, serving as inlet compartments, are respectively provided with a first feed port and a second feed port; and the two material compartments of the discharge chamber, serving as outlet compartments, are respectively provided with a first discharge port and a second discharge port;
wherein the tray assembly consists of a fan-shaped partition plate and a fan-shaped perforated plate;
wherein the partition assembly consists of a square partition plate and a square grid plate;
wherein the adsorption chambers each are filled with a basic alumina adsorbent, wherein the adsorption chambers of different stages are filled with adsorbent particles of different particle sizes; and the adsorption chamber of each stage is provided with two unloading ports; and
wherein the inlet compartment and the outlet compartment are filled with ceramic balls.

Further, each of the tray assemblies consists of two fan-shaped partition plates and two fan-shaped perforated plates, wherein the fan-shaped partition plates and the fan-shaped perforated plates are arranged alternately, and the fan-shaped partition plates and the fan-shaped perforated plates in adjacent tray assemblies are staggered in an axial direction of the tower body.

Further, each of the partition assemblies in each adsorption chamber consists of two square partition plates and two square grid plates, wherein the square partition plates and the square grid plates are arranged alternately, and the square partition plates and the square grid plates in adjacent partition assemblies are staggered in an axial direction of the tower body, wherein a side of the square partition plate is coupled to the support plate with a hinge, and the feed chamber and the discharge chamber each are divided by a square partition plate.

Further, the first-stage adsorption chamber comprises an adsorption layer in a thickness of 1.5-3 m, and adsorbent particles in a particle size of 6-10 mm; the second-stage adsorption chamber comprises an adsorption layer in a thickness of 1-2 m, and adsorbent particles in a particle size of 4-8 mm; and the third-stage adsorption chamber comprises an adsorption layer in a thickness of 0.5-1.5 m, and adsorbent particles in a particle size of 2-5 mm.

Further, the fan-shaped perforated plate and the square grid plate comprise through holes having an equivalent pore diameter of 2-5 mm, and an open porosity of 40%-70% for each of them, and an individual pore diameter of the fan-shaped perforated plate and an individual rectangular hole of the square grid plate are both smaller than a particle size of an adjacent adsorbent.

The present disclosure further provides a process for desorption regeneration of an adsorbent by combing liquid medium flushing and nitrogen purge. The adsorption efficiency and the adsorption uniformity can be improved according to the present disclosure, and the adsorption process and the desorption process can be performed synchronously.

Further, a process for desorption regeneration of an adsorbent in the multi-channel adsorption tower, comprising the following steps:
a material to be purified enters from the first feed port and the second feed port, wherein the material entering from the first feed port enters the material compartment through the fan-shaped perforated plate at a bottom of the first-stage adsorption chamber in communication with the first feed port, passes through the square grid plate of this material compartment, and enters the material compartments of the second-stage adsorption chamber and the third-stage adsorption chamber in sequence through the fan-shaped perforated plates and square grid plates of each stage, wherein a clean material resulting from adsorption treatment with the adsorbent in the three stages of adsorption chambers enters the first discharge port in communication with the fan-shaped perforated plate at a top of the third-stage adsorption chamber, and is discharged from the first discharge port, thus forming a first path for material transportation;
at the same time, the material entering from the second feed port enters the material compartment through the fan-shaped perforated plate at the bottom of the first-stage adsorption chamber in communication with the second feed port, passes through the square grid plate of this material compartment, and enters the material compartments of the second-stage adsorption chamber and the third-stage adsorption chamber in sequence, wherein a clean material resulting from adsorption treatment with the adsorbent in the three stages of adsorption chambers enters the second discharge port in communication with the fan-shaped perforated plate at the top of the third-stage adsorption chamber, and is discharged from the second discharge port, thus forming a second path for material transportation;
when the adsorbent in the first path is saturated by adsorption, feeding to the first feed port is stopped, and a remaining material in the first path is extracted through the first feed port; after all the material is extracted out, low-temperature water is first injected from the first discharge port to flush the adsorbent in the first path; after the flushing is completed, low-temperature nitrogen is then introduced into the first discharge port to purge the adsorbent, so as to fulfill desorption regeneration treatment on the basic alumina adsorbent by a combined process of liquid flushing and nitrogen purge; after the adsorbent is regenerated, it is cooled before an adsorption operation is performed; and, after the adsorbent in the second path is saturated by adsorption, the same desorption regeneration treatment is performed.

Further, adsorption operation proceeds in the two paths simultaneously, or desorption regeneration proceeds in the two paths simultaneously, or adsorption operation and desorption regeneration proceed in the two paths, respectively.

Further, the material to be purified flows at a rate of 0.001-0.1 m/s in the tower, and water and nitrogen flow at a rate of 0.05-0.5 m/s in the tower.

Further, water flushing occurs at a temperature of 40-80° C. for a flushing time of 12-24 h, and nitrogen purge occurs at a temperature of 50-70° C. for a purge time of 20-40 min.

### Effective Benefits

Compared with the prior art, the present application provides the following technical effects:
(1) The adsorption path formed by the arrangement of the tray assemblies and the partition assemblies in the adsorption tower can significantly prolong the contact time between the material and the adsorbent, and improve the utilization rate of the adsorbent. At the same time, the square grid plate and the through-holes of the fan-shaped perforated plate not only have a diversion effect, but also can disperse the material effectively, and eliminate the dead zone in the adsorption tower, thereby improving the adsorption purification effect significantly.
(2) The two paths arranged in the adsorption tower enable simultaneous proceeding of adsorption and desorption, so that the adsorption process is not interrupted, thereby significantly increasing the material processing capacity of the adsorption system per unit time.
(3) The basic alumina particles are selected as the adsorbent and arranged in grades according to particle size, which allows for effective removal of sulfur-containing matters from the material and improvement in product quality. In addition, the loss rate of the adsorption performance of the basic alumina adsorbent is low after regeneration, while the regeneration conditions are simple, and the operation is convenient.
(4) The use of the regeneration process combing low-temperature liquid medium flushing and low-temperature nitrogen purge can not only reduce the heat loss of the adsorption material, but also significantly restore the adsorption performance of the adsorbent, thereby improving the recycling rate of the adsorbent.

### DESCRIPTION OF THE DRAWINGS

The accompanying drawings are used to provide a further understanding of the present disclosure. They only constitute a part of this specification to further explain the present disclosure, and do not constitute a limitation to the present disclosure.

FIG. 1 is a schematic view showing a structure of a multi-channel adsorption tower and two paths for material transportation according to the present disclosure.

FIG. 2 is a three-dimensional view showing a multi-channel adsorption tower according to the present disclosure;
wherein 1—tower body; 2—upper head; 3—lower head; 4—unloading port; 21—first discharge port; 22—second discharge port; 31—first feed port; 32—second feed port.

FIG. 3 is a schematic view showing a multi-channel adsorption tower in which adsorption operation and desorption regeneration proceed simultaneously according to the present disclosure.

FIG. 4 is a schematic view showing a cross-section of a multi-channel adsorption tower filled with an adsorbent and ceramic balls according to the present disclosure;
wherein 12—inlet compartment; 13—first-stage adsorption chamber; 14—second-stage adsorption chamber; 15—third-stage adsorption chamber; 16—outlet compartment.

FIG. 5 is a schematic view showing a structure of a fan-shaped perforated plate;
wherein 61—gas-liquid through hole of the fan-shaped perforated plate.

FIG. 6 is a schematic view showing a structure of a square grid plate;
wherein 71—gas-liquid through hole of the square grid plate; 72—hinge.

### DETAILED DESCRIPTION

In order to make the object, technical solutions and technical advantages of the present disclosure clearer, the present disclosure is further described in detail below with reference to the accompanying drawings and the Examples. It should be understood that the specific Examples described herein are intended to illustrate the present disclosure, not to limit the present disclosure.

The specific implementation of the present disclosure is described in detail below with reference to the specific Examples.

### Example 1

The adsorption tower and the desorption regeneration process according to the present disclosure were used to desulfurize an alkylate oil from a petrochemical plant.

Process conditions: The total sulfur content in the alkylate oil: 20-50 mg/L; 65° C. process water; and 65° C. low-temperature nitrogen.

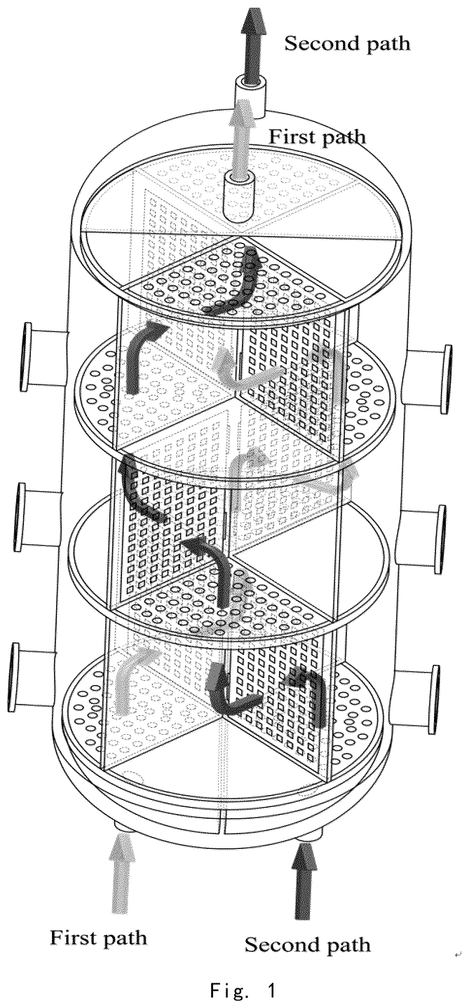

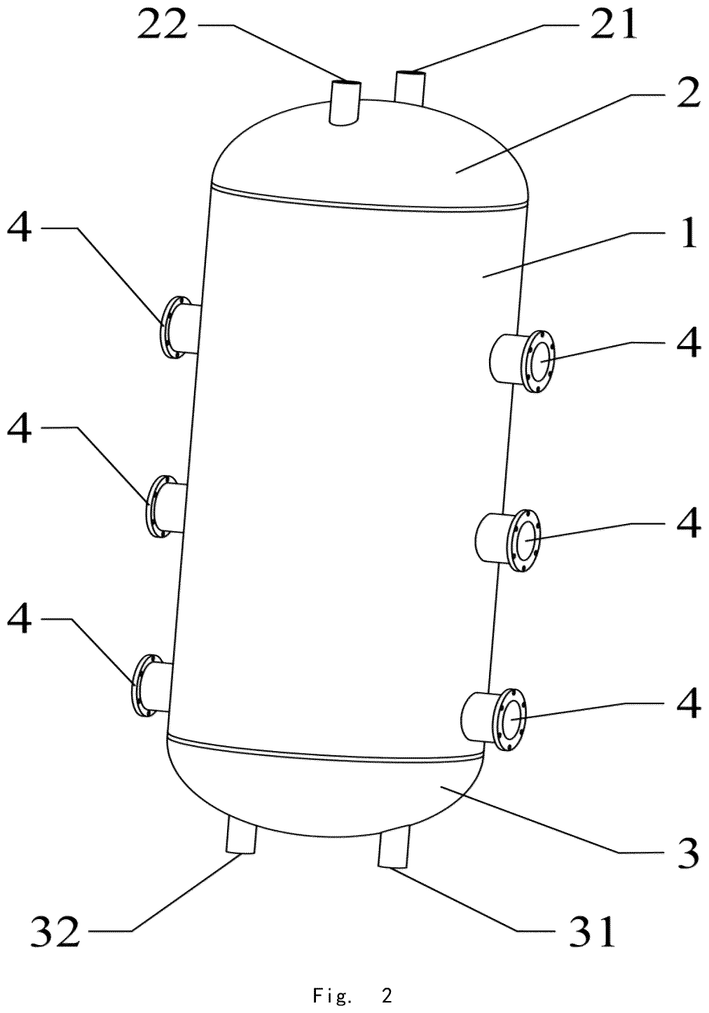

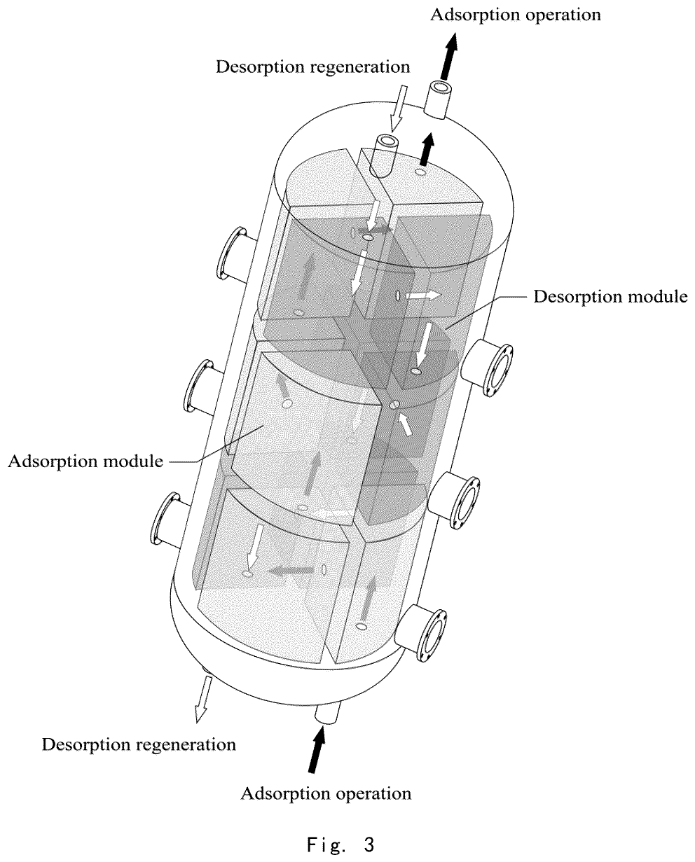

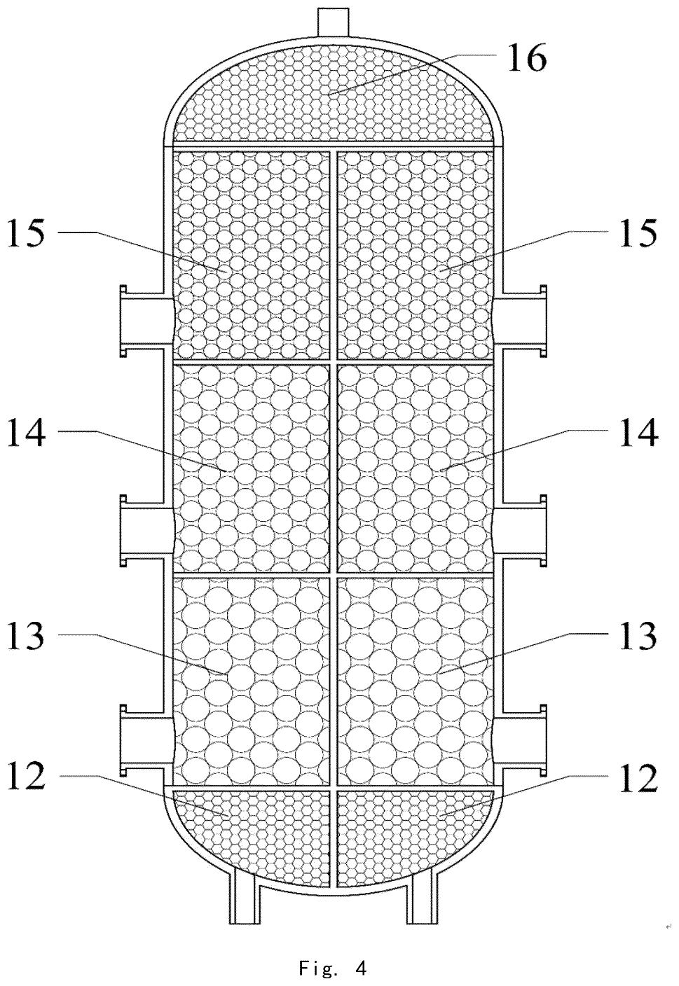

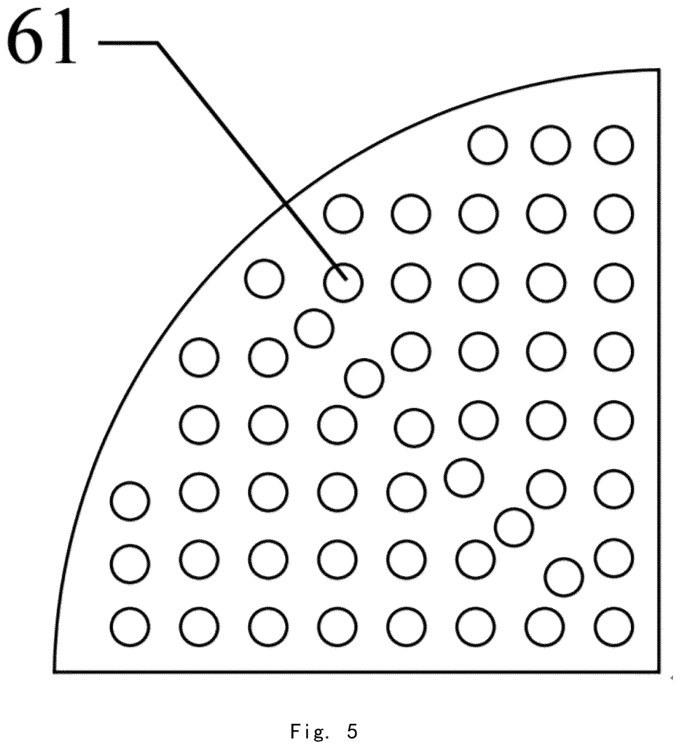

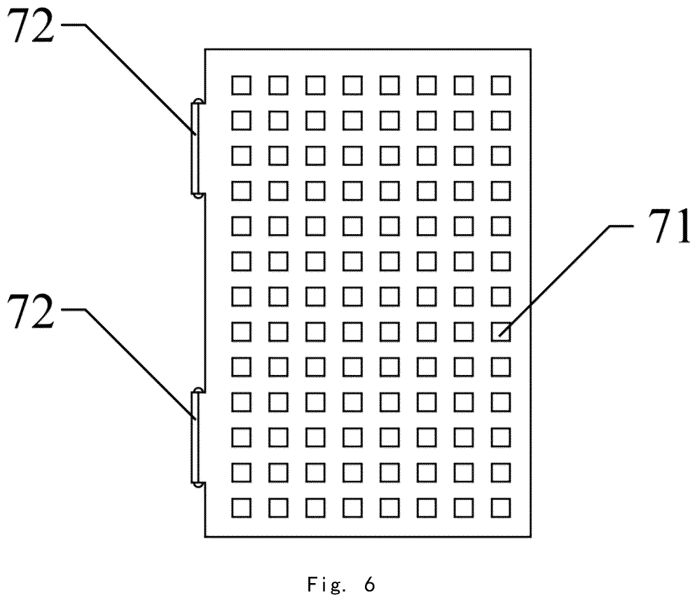

Equipment conditions: The equipment is shown in FIG. 1-6. The particle sizes of the basic alumina adsorbent particles filled in the first-stage adsorption chamber, the second-stage adsorption chamber and the third-stage adsorption chamber were 10 mm, 8 mm and 5 mm, respectively. The equivalent pore diameter of the fan-shaped perforated plate and the square grid plate was 5 mm. The thickness of the adsorption layer in the first-stage adsorption chamber was 1.5 m; the thickness of the adsorption layer in the second-stage adsorption chamber was 1 m; and the thickness of the adsorption layer in the third-stage adsorption chamber was 0.8 m. The flow rate of the alkylate oil in the tower was 0.005 m/s, and the flow rate of the process water and nitrogen in the tower was 0.5 m/s.

Operation process: The sulfur-containing alkylate oil entered from the first feed port and the second feed port, flowed through the first path and the second path, and was desulfurized by adsorption with the adsorbent in the three adsorption chambers. After the adsorption, the clean alkylate oil was discharged from the first discharge port and the second discharge port, while the total sulfur content of the alkylate oil was detected at the discharge port. When the total sulfur content at the discharge port exceeded 10 mg/L, the adsorbent in the tower was saturated by adsorption. Feeding of the alkylate oil to the second feed port was continued, while feeding of the alkylate oil to the first feed port was stopped. The remaining alkylate oil in the first path was extracted through the first feed port, and regeneration operation was performed on the adsorbent. First, 65° C. process water was injected from the first discharge port to flush the adsorbent in the first path for 18 h. After flushing, 65° C. nitrogen was introduced into the first discharge port to purge the adsorbent for 30 min. After the purge was completed, the low-temperature nitrogen system was shut off. After the tower body was allowed to cool for 30 min, the sulfur-containing alkylate oil was inject from the first feed port, and the purified gas was discharged through the first discharge port. After the desorption regeneration of the adsorbent in the first path was completed, feeding of the alkylate oil to the second feed port was stopped, and desorption regeneration of the adsorbent in the second path was carried out according to the above steps.

Determination method: The total sulfur was determined according to SH/T 0253-1992 “Method for determining total sulfur content in light petroleum products (coulometric method)”.

Application effects: After the alkylate oil was desulfurized using the method and equipment according to the present disclosure, the total sulfur content could be reduced to 3 mg/L or lower; after regeneration of the basic alumina adsorbent, the adsorbent's saturated adsorption capacity could reach 80% of the original adsorption capacity, indicating effective restoration of the adsorption performance of the adsorbent.

### Example 2

The process and the equipment of the present disclosure were used in a process for regeneration of a basic alumina adsorbent used in desulfurization of natural gas in a refinery plant.

Process conditions: hydrogen sulfide content in natural gas: 200 mg/m³; 70°C. process water; 70° C. low-temperature nitrogen.

Equipment conditions: The equipment is shown in FIG. 1-6. The particle sizes of the basic alumina adsorbent particles filled in the first-stage adsorption chamber, the second-stage adsorption chamber and the third-stage adsorption chamber were 9 mm, 7 mm and 4 mm, respectively. The equivalent pore diameter of the fan-shaped perforated plate and the square grid plate was 4 mm. The thickness of the adsorption layer in the first-stage adsorption chamber was 1.5 m; the thickness of the adsorption layer in the second-stage adsorption chamber was 1 m; and the thickness of the adsorption layer in the third-stage adsorption chamber was 0.8 m. The flow rate of the natural gas in the tower was 0.002 m/s, and the flow rate of the process water and nitrogen in the tower was 0.2 m/s.

Operation process: When the adsorbent in the first path was saturated by adsorption, feeding of the natural gas to the first feed port was stopped, and the remaining natural gas in the first path was extracted through the first feed port. At the same time, the hydrogen sulfide content of the natural gas after the adsorption with the adsorbent was measured, followed by the operation of regenerating the adsorbent. First, 70° C. process water was injected from the first discharge port to flush the adsorbent in the first path for 24 h. After the flushing was completed, the valve of the low-temperature nitrogen system was opened, and 70° C. nitrogen was introduced into the first discharge port to purge the adsorbent for 40 min. After the purge was completed, the low-temperature nitrogen system was shut off. After the tower body was allowed to cool for 30 min, the natural gas to be purified was injected from the first feed port. The purified gas was discharged through the first discharge port. The hydrogen sulfide content of the natural gas was measured after the adsorbent was saturated again.

Determination method: The iodimetric method described in GB/T 17820-2018 was used to determine the hydrogen sulfide content of the natural gas after the adsorption with the adsorbent.

Application effects: After the natural gas was desulfurized using the method and equipment according to the present disclosure, the hydrogen sulfide content could be reduced to 10 mg/L or lower. After the basic alumina adsorbent was regenerated using the method and equipment according to the present disclosure, the saturated adsorption capacity of the adsorbent was 13.47 mg/g, 82% of the original adsorption capacity of the adsorbent (16.39 mg/g). After single regeneration, the loss of the adsorption performance was 18%. The regeneration effect is good, and the adsorption performance of the adsorbent is restored effectively.

Described above are only some preferred Examples of the present disclosure, which do not limit the present disclosure in any way. Any simple modification, change and equivalent transformation made to the above Examples based on the technical essence of the present disclosure still fall within the protection scope of the technical solution of the present disclosure.

What is claimed is:

1. A multi-channel adsorption tower, wherein the adsorption tower comprises: a tower body, an upper head, a lower head, tray assemblies, partition assemblies, a support plate, ceramic balls and an adsorbent;
wherein the adsorption tower is divided from bottom to top into a feed chamber; adsorption chambers comprising a first-stage adsorption chamber, a second-stage adsorption chamber, and a third-stage adsorption chamber; and a discharge chamber in sequence by the tray assemblies, wherein the feed chamber and the discharge chamber each are equally divided into two material compartments by the partition assemblies; each adsorption chamber is equally divided into four material compartments by the partition assemblies; the feed chamber is located in the lower head; the adsorption chamber of each stage is located in the tower body; the discharge chamber is located in the upper head; the support plate is welded to an inner wall of the adsorption tower for supporting the tray assemblies and the partition assemblies; the two material compartments of the feed chamber, serving as inlet compartments, are respectively provided with a first feed port and a second feed port; and the two material compartments of the discharge chamber, serving as outlet compartments, are respectively provided with a first discharge port and a second discharge port;
wherein each of the tray assemblies consists of a fan-shaped partition plate and a fan-shaped perforated plate;
wherein each of the partition assemblies consists of a square partition plate and a square grid plate;
wherein the adsorption chambers each are filled with a basic alumina adsorbent, the adsorption chambers of different stages are filled with adsorbent particles of different particle sizes; and the adsorption chamber of each stage is provided with two unloading ports; and
wherein the inlet compartment and the outlet compartment are filled with ceramic balls.

2. The multi-channel adsorption tower according to claim 1, wherein each of the tray assemblies consists of two fan-shaped partition plates and two fan-shaped perforated plates, wherein the fan-shaped partition plates and the fan-shaped perforated plates are arranged alternately, and the fan-shaped partition plates and the fan-shaped perforated plates in adjacent tray assemblies are staggered in an axial direction of the tower body.

3. The multi-channel adsorption tower according to claim 1, wherein each of the partition assemblies in each adsorption chamber consists of two square partition plates and two square grid plates, wherein the square partition plates and the square grid plates are arranged alternately, and the square partition plates and the square grid plates in adjacent partition assemblies are staggered in an axial direction of the tower body, wherein a side of the square partition plate is coupled to the support plate with a hinge, and the feed chamber and the discharge chamber each are divided by a square partition plate.

4. The multi-channel adsorption tower according to claim 1, wherein the first-stage adsorption chamber comprises an adsorption layer in a thickness of 1.5-3 m, and adsorbent particles in a particle size of 6-10 mm; the second-stage adsorption chamber comprises an adsorption layer in a thickness of 1-2 m, and adsorbent particles in a particle size of 4-8 mm; and the third-stage adsorption chamber comprises an adsorption layer in a thickness of 0.5-1.5 m, and adsorbent particles in a particle size of 2-5 mm.

5. The multi-channel adsorption tower according to claim 1, wherein the fan-shaped perforated plate and the square grid plate comprise through holes having an equivalent pore diameter of 2-5 mm, and an open porosity of 40%-70% for each of them, and an individual pore diameter of the fan-shaped perforated plate and an individual rectangular hole of the square grid plate are both smaller than a particle size of an adjacent adsorbent.

6. A process for desorption regeneration of an adsorbent in the multi-channel adsorption tower according to claim 1, comprising the following steps:
a material to be purified enters from the first feed port and the second feed port, wherein the material entering from the first feed port enters the material compartment through the fan-shaped perforated plate at a bottom of the first-stage adsorption chamber in communication with the first feed port, passes through the square grid plate of this material compartment, and enters the material compartments of the second-stage adsorption chamber and the third-stage adsorption chamber in sequence through the fan-shaped perforated plates and square grid plates of each stage, wherein a clean material resulting from adsorption treatment with the adsorbent in the three stages of adsorption chambers enters the first discharge port in communication with the fan-shaped perforated plate at a top of the third-stage adsorption chamber, and is discharged from the first discharge port, thus forming a first path for material transportation;
at the same time, the material entering from the second feed port enters the material compartment through the fan-shaped perforated plate at the bottom of the first-stage adsorption chamber in communication with the second feed port, passes through the square grid plate of this material compartment, and enters the material compartments of the second-stage adsorption chamber and the third-stage adsorption chamber in sequence through the fan-shaped perforated plates and square grid plates of each stage, wherein a clean material resulting from adsorption treatment with the adsorbent in the three stages of adsorption chambers enters the second discharge port in communication with the fan-shaped perforated plate at the top of the third-stage adsorption chamber, and is discharged from the second discharge port, thus forming a second path for material transportation;
when the adsorbent in the first path is saturated by adsorption, feeding to the first feed port is stopped, and a remaining material in the first path is extracted through the first feed port; after all the material is extracted out, low-temperature water is first injected from the first discharge port to flush the adsorbent in the first path; after the flushing is completed, low-temperature nitrogen is then introduced into the first discharge port to purge the adsorbent, so as to fulfill desorption regeneration treatment on the basic alumina adsorbent by a combined process of liquid flushing and nitrogen purge; after the adsorbent is regenerated, it is cooled before an adsorption operation is performed; and, after the adsorbent in the second path is saturated by adsorption, the same desorption regeneration treatment is performed.

7. The process according to claim 6, wherein adsorption operation proceeds in the two paths simultaneously, or desorption regeneration proceeds in the two paths simultaneously, or adsorption operation and desorption regeneration proceed in the two paths, respectively.

8. The process according to claim 6, wherein the material to be purified flows at a rate of 0.001-0.1 m/s in the tower, and water and nitrogen flow at a rate of 0.05-0.5 m/s in the tower.

9. The process according to claim 6, wherein water flushing occurs at a temperature of 40-80°C. for a flushing time of 12-24 h, and nitrogen purge occurs at a temperature of 50-70°C. for a purge time of 20-40 min.
